(19) United States
(12) Patent Application Publication
(10) Pub. No.: US 2010/0157851 A1
(43) Pub. Date: Jun. 24, 2010

(54) Information System for Telecommunications

(76) Inventor: Anthony Robert Farah, New South Wales (AU)

Correspondence Address: BRYAN CAVE LLP, TWO NORTH CENTRAL AVENUE, SUITE 2200, PHOENIX, AZ, 85004, US

(21) Appl. No.: 11/993,392

(22) PCT Filed: Jun. 20, 2006
(86) PCT No.: PCT/AU06/00857

§ 371 Date: Jul. 16, 2008

(30) Foreign Application Priority Data
Jun. 20, 2005 (AU) 2005202680

(51) Int. Cl. H04L 12/16

(52) U.S. Cl. 370/260

(57) ABSTRACT

A profiling system for establishing communication between a plurality of parties (20A, 20B) is disclosed. The profiling system includes a server (12) connected to a communications network (50). The server (12) includes a database (14) for storing user profiles, wherein each of said plurality of parties (20A, 20B) has an associated user profile and each profile includes a calling identity. The server also includes a processor (15) for processing data contained in said user profiles to determine a match between at least two of said plurality of parties (20A, 20B) in accordance with predetermined criteria. The server further includes and a call handling module (16) for initiating a call in the communications network (50) to at least two of the marching parties (20A, 20B) to establish communication between the matching parties (20A, 20B) without presenting the calling identity associated with a user to any other party.

### FIELD OF THE INVENTION

The present invention relates to methods and systems for communicating between parties and, in particular, for connecting two or more parties without providing either party with calling identification information.

### BACKGROUND

In numerous systems for communication between parties, it is common for each party to have an identifier. That identifier may be referred to as a calling line identifier and can be a telephone number, an email address, a device identifier, or an Instant Messaging Identifier, for example. For the purposes of maintaining anonymity, methods such as blocking or masking (via a proxy system) the presentation of identifiers to a receiving party and/or restricting access to either party may have disadvantages. Blocking or restricting access to either party as a method of security does not support full party privacy as the identification information is previously known to at least one, and often all parties.

There is an ever growing concern for personal safety, and this typically impacts upon communication privacy issues. Blocking or restricting access is becoming more popular. For systems and businesses that are based around social networking, special interest groups, human resource services, adult dating, or occupational recruitment services, blocking or restricting access makes present systems impractical.

Masking identification information with proxy identification information imposes significant administrative overheads to calling parties, telecommunication service providers and carriage providers. Calling parties have to remember or store the proxy identification information, telecommunication service providers have to maintain call forwarding or identification information translation lists, and carriage providers have to support the system's functionality. Nevertheless, masking identification information will not offer total privacy as a method of security, and does not support full party privacy as the proxy identification information is previously known to both parties. Blocking or restricting access of a proxy number is still required and further administration to re-allocate proxy numbers to either or all parties also needs to occur.

Thus, a need exists to provide a method for connecting two or more parties in an anonymous fashion such that the calling line identifier associated with each party is not provided to any other party connected to the call.

### SUMMARY

The present disclosure provides a system for and a method of connecting two or more parties into a voice call, a video call, or a video conference, without a requirement for any party to provide any of their identification details to any other party of the call. Such a system and method may be utilised, for example, for connecting interested parties in relation to special interest groups, human resource services, dating systems, social networking systems, and occupational recruitment services in which it is desirable for the initial communication between parties to be non-intrusive and private.

According to a first aspect of the present disclosure, there is provided a method of forming an end-to-end communication between at least two communication devices, each communication device being connected to a communication network and having at least one associated calling identity. The method includes the steps of:

(a) receiving, at a third party in a packet-switched communication network, a communication from a first communication device indicating at least an availability for communications, the indication including an identifier of the first communication device;

(b) identifying, at the third party, at least one second communication device as available for compatible communications with the first communication device, the availability being advised via a packet-switched communication derived from the second communication device, the identifying including an identifier of the second communication device;

(c) instigating, from the third party, a call to the first communication device and a call to the second communication device, each based upon the corresponding identifiers; and

(d) upon establishment of each call to the first and second communication devices, joining the calls such that the communication devices are in an end-to-end communication, the joining occurring without transfer of the associated calling identities between the communication devices.

According to a second aspect of the present disclosure, there is provided a method of forming an end-to-end communication between at least two communication devices. The method includes the steps of:

(a) receiving at a third party a communication derived from a first communication device, the communication including an identifier of the first communication device;

(b) identifying, at the third party at least one second communication device as available for compatible communications with the first communication device, the availability being advised by a communication derived from the second communication device, the identifying including an identifier of the second communication device;

(c) instigating, from the third party, respective calls to each of the first and second communication devices using the corresponding identifiers and, on establishment of the calls, joining the calls to establish end-to-end communication between the first and second communication devices, the joining occurring without transfer of call identities between the communication devices.

According to a third aspect of the present disclosure, there is provided a system for forming an end-to-end communication between at least two communication devices. The system includes:

a first communication device having an associated calling identity; at least one second communication device having an associated calling identity;

a communication network permitting communications between each of the communication devices;

a server connected to the communication network, the server including:
a device for receiving a communication from the second communication device indicating an availability of that device for receipt of a call;
a device for receiving a communication from the first communication device indicating an availability for communication with at least one of the other communication devices;
a device for matching a profile associated with the first communication device to a profile associated with at least one of the second communication devices;
a device for instigating, via the communication network and utilising the calling identities, a call to the first communication device and a call to the second communication device associated with the matched profile; and
a device for joining the calls to the respective devices to establish an end-to-end communication between the communication devices associated with the matched profiles, without disclosing the associated calling identities to any other communication device in the joined call.

According to a fourth aspect of the present disclosure, there is provided a system for forming an end-to-end communication between at least two to communication devices. The system includes:

at least one first communication device having a circuit-switched mode of operation and a packet-switched mode of operation;

at least one second communication device having a circuit-switched mode of operation and a packet-switched mode of operation, each of the devices incorporating an associated call identity communicable via communications made therewith;

a communication network incorporating both packet-switched and circuit-switched networks and permitting communications between each of the communication devices; and

a server connected for at least packet-switched communication with the communication network, the server comprising:
a device for receiving a packet-switched communication from the second communication device indicating an availability of that device for receipt of a circuit-switched call;
a device for receiving an indication from the first communication device as to its availability for circuit-switched communication; and
a device for instigating, via the communication network, at least a circuit-switched communication call to the second communication device and for joining of that call to the first communication device such that the call identities of each of the devices is unknown to each of those devices as a result of the joined call.

According to a fifth aspect of the present disclosure, there is provided a server apparatus for enabling communication between at least two communication devices. The server apparatus includes:

a module for identifying availability of a first communication device for receipt of a call, the server receiving a call identity associated with the first communication device in a communication from the first communication device;

a communication module for receiving a communication from at least one second communication device, the communication at least including an indication of availability of one of the communication devices for receipt of a call and a calling identity associated with the second communication device;

a module for matching a user profile associated with the first communication device with a user profile associated with the second communication device; and

a module for causing a communication network to establish a joined call connection between the matched first and second communication devices in such a fashion that the devices are unaware of the calling identities associated with each of the other of the devices.

According to a sixth aspect of the present disclosure, there is provided a profiling system for establishing communication between a plurality of parties. The profiling system includes:

a server connected to a communications network, wherein the server includes:
a database for storing user profiles, wherein each of the plurality of parties has an associated user profile;
a processor for processing data contained in the user profiles to determine a match between at least two of the plurality of parties in accordance with predetermined criteria; and
a call handling module for initiating a call in the communications network to at least two of the matching parties to establish communication between the matching parties.

Some implementations to be described provide users with an option to profile themselves and be connected to similar users without the explicit requirement to provide any of their profile information (including, but not limited to, their identification information) for the purposes of establishing a call. Desirably, this is incorporated into or associated with a system and method for facilitating automated connection of parties for social networking, human resource services, occupational recruitment services, or special interest groups. Further, initiation of the call may be by either party or by an automated information system whereby the two or more parties are contacted and joined into a call.

### BRIEF DESCRIPTION OF THE DRAWINGS

At least one embodiment of the present invention will now be described with reference to the drawings in which:

FIG. 1 is a schematic representation illustrating interactions between a calling party(s) and a receiving party(s) within an information system;

FIG. 2 is a schematic representation illustrating relationships among types of information of the calling parties and the actions that can be taken in using the system of FIG. 1;

FIG. 3 schematically illustrates various components of the information system of FIG. 1;

FIG. 4 is a flowchart illustrating the overall operation of the interaction between calling parties and the information system;

FIGS. 5, 6 and 7 illustrate the sub-processes of various processes of the flowchart of FIG. 4;

FIG. 8 is a flowchart for processing user feedback;

FIG. 9 is a schematic block diagram representation of a computer system that may be used to implement the described arrangements;

FIG. 10 is a schematic representation of a combination of FIGS. 1 and 2 of an alternate arrangement; and

FIG. 11 illustrates profile browsing in the system of FIG. 10.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

Throughout this specification, including the claims annexed hereto:
the expression ‘party’, ‘user’ and, ‘caller’, in both plural and singular is to be understood as including, but is not limited to, fixed line telephone users, desktop video phone users, mobile phone users, wireless broadband mobile users, and any wireless mobile devices that provide communication between two or more users;
the expression ‘data’ is used as including any one or more of text, audio, and video data;
the expression ‘identification information’ is to be understood as any data which would identify the calling party(s) or the receiving party(s) before, during or after the communication between either/all parties had occurred; and
the expression ‘profile’ relates to all information relating to a party which is provided explicitly by the user or another Information System or implied through the use of the Information System.

The present disclosure provides a system for and a method of establishing an end-to-end communication link between two or more parties without disclosing the identification details of any one party to any other party of the communication. An information system is provided, and is preferably linked to a packet-switched network, for storing user profiles, matching users according to predetermined criteria, and establishing calls to suitably matched users without disclosing private identification information associated with the respective users.

The information system is typically aligned with a particular service. Such services may include, but are not limited to, a special interest group such as woodworking or stamp collecting, a social networking service, an adult dating service, a human resource service, or an occupational recruitment service. Potential users of the service may be attracted by various promotional activities associated with the service, including advertisements on various media, including radio, television, websites, email, and Internet search engines.

In one embodiment, the information system includes a web application server connected to a packet-switched communication network for storing profiles associated with users of the service. A user browses content on the web application server and establishes an associated profile via a packet-switched connection. The user interacts with the web application server via a computer terminal, or a mobile handset with data capability, or other communication device capable of exchanging data with the web application server. When establishing a profile, a user may complete a survey or answer a questionnaire provided on the web application server. When the user utilises a mobile handset to interact with the web application server, the web application server optionally utilises information from the call to construct a user profile. Such call information can include the calling line identity, call duration, and call frequency. Further, in some circumstances it may be possible for the information system to determine the user's geographical location, service provider, or other user information from an analysis of the calling line identifier or other associated call information.

In another embodiment, a user calls a telephone number associated with the information system and provides pertinent information to a human operator, who enters the required information into the web application server or an associated database to establish a profile for the user. In a further embodiment, a user calls a telephone number associated with the information system and establishes a profile by responding to an automated menu through the use of Dual Tone Multi Frequency tones generated from keys on a telephone keypad. A microprocessor on the web application server processes the responses from the user to establish an associated profile.

Once a user has established a profile, it is necessary for the user to inform the information system to turn the profile “on”. This may be done by establishing a call to the information system or by sending appropriate data to the information system. In one embodiment, a user utilises a 3G mobile handset to browse the web application server of the information system and clicks on a link or checkbox on a web page provided by the web application server to activate the profile.

Turning the profile “on” indicates that the user is available for communication with other users that meet a predetermined compatibility threshold, as determined from the respective profiles associated with the users. In a simple scenario, having a profile switched “on” at the same time may be sufficient to establish a match between two users of the information system. A user's profile is maintained by the information system and may be updated by the user over time. The user can turn the profile “on” and “off” on a session basis, as the user's availability permits.

When a user switches the associated profile to “on”, the information system determines whether there are any other suitably matched users that are also switched “on”. In one embodiment, the information system matches users dynamically by comparing profiles associated with users that are currently “on”. In an alternate embodiment, the information system pre-processes information contained in the user profiles to establish potential matches for a nominal user. When that user switches “on”, the information system determines whether any of the potential matches are also switched “on”.

The information system determines whether any two or more users that are switched “on” meet a predetermined level of compatibility based on their respective profiles. In one embodiment, the level of compatibility includes the type of communication supported by each user. This enables the information system to establish a voice call when connecting parties with traditional circuit-switched telephone handsets that are not capable of supporting video calls, and a video call when connecting matching parties that possess mobile handsets or other communication devices that are capable of supporting video calls.

When two or more users are deemed to be compatible, the information system utilises the information contained in the user profiles to initiate a call to each of the respective users, without providing private information associated with any of the other matched users. In some embodiments, it may be desirable to provide a proxy name or other non-private information associated with the other matched users. The provision of a proxy name or other non-private user information is approved by the users and does not contain the calling line identifier. Each of the calls to the matched users may be initiated by sending a call request over the packet-switched network to an appropriate gateway operated by a telecommunications service provider, which subsequently establishes a through-connection to the user. The call request may utilise known Voice on Internet Protocol (VoIP) protocols, TCP/IP, or SIP, for example.

If a user possesses a handset connected to a circuit-switched network, such as is the case with a Groupe Special Mobile/Global System for Mobile Communications (GSM) handset, the establishment of a call from the gateway to that user requires the use of an Internet Protocol (IP) adapter (typically an Internet Protocol Multimedia Subsystem (IMS) adapter), or other suitable bridge, to facilitate communication between the packet-switched network in which the information system resides and the circuit-switched network to which the user's handset is connected. If the user possesses a handset or communication device that is capable of establishing a voice or video call in a packet-switched network connected to the gateway, such as may be the case for example in an Internet Protocol (IP) based mobile network, there may not be any need for such a bridging adapter and packet-switched communication can be established from the information system to the user's handset or communication device.

Having established a call to each of the matched users without providing private information associated with the other matched users, the information system connects the calls in a conferencing environment to provide an end-to-end communication link between the two or more matched users.

In an alternate embodiment, once two or more users are deemed to be compatible, the information system sends call request instructions to a carrier video gateway. The call request instructions include the calling line identifiers associated with each of the users and instruct the carrier video gateway to establish a call between the compatible users, such that the calling line identifiers are not presented to any of the users. In such an embodiment, the carrier gateway connects the call between the compatible users without requiring conferencing to be performed by the information system.

In another “profile browsing” embodiment, a user utilises a mobile handset or communication device with data capability to browse content on the web application server of the information system. Such a mobile handset may be, for example, a 3G enabled handset operating on a WCDMA network. The content available for display to the user may be determined by the user's own profile, access rights attributed to the user based on a subscription, or the profiles of users that are presently switched “on”.

The browsing user finds a target user with whom the browsing user wants to establish contact, and clicks on a provided link associated with the target user. The information system utilises information contained in the profile of the target user to send a call request via the packet-switched network to establish a call of an appropriate call type, such as voice or video, to the target user without providing private information associated with the browsing user. The information system then conferences a call to the browsing user and the call to the target user to establish an end-to-end communication link between the two users. In an alternate embodiment, the establishment of the call to the target party creates the end-to-end connection between the browsing user and the target user and there is no need to use conferencing facilities to link the two users.

According to an aspect of the present disclosure, there is provided a system for connecting two or more parties without providing either party with any calling party identification information. The system includes a database which includes information relating to each party. Such information may include, for example, each party's identification information, mobile device, mobile device technology and mobile device capabilities. The system further includes a device for updating the contents of the database, and a device for providing access to the database by all parties.

According to another aspect of the present disclosure, there is provided a method of connecting two or more parties without the need to provide either or all parties with caller identification information. The method includes the step of storing, in a database, profile information which includes information relating to each of a plurality of possible calling parties. The profile information may include, but is not limited to, a party name, name alias, sex, calling identifier, picture, video, vital statistics, time information, work skills, work experience, intelligence quotient, emotional intelligence score, social preferences, personal biases, demography and geography. The method further includes the steps of processing the profile information to provide a matching between at least one pair of the parties, establishing a call to each of the matched parties, and conferencing the calls to connect the matched parties.

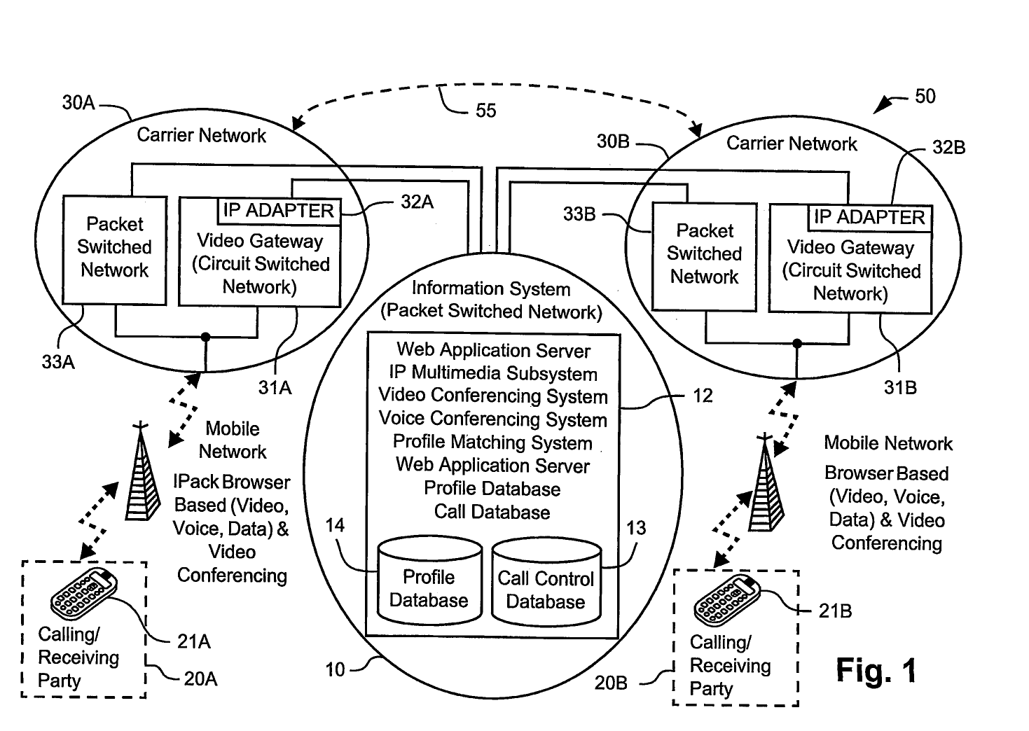

FIG. 1 shows an information system 10 forming part of a network and which incorporates an application server 12. In the example shown, the network is a packet-switched network, such as the Internet, for example. The information system 10 receives user profile information and requests to communicate from two or more users of a wider communications system 50. The user profile information submitted to the system 10 and generated from user activity is stored in a profile database 14. Information about the initiation, connection and termination of calls made between two or more parties is stored in a call control database 13. Such information may include, for example, the respective parties' calling line identifiers, times of calls, and duration of calls. Each of the databases 13 and 14 preferably resides upon the server 12, which is desirably configured to operate according to known Internet protocols and hence may be considered a web application server 12.

Operating within the communications system 50 are a number of users 20A, 20B . . . , each of which is in possession of a corresponding communications device. In the example shown, the communications devices are mobile handsets 21A, 21B . . . . In other embodiments, the communications devices are desktop-based video phones, traditional fixed-line telephone handsets, or personal computers. The handsets 21 are preferably third generation (3G) wireless telephone handsets which have a two-way media capability encompassing each of voice, video, and data. This capability enables traditional voice-to-voice telecommunications, video-to-video telecommunications, and also data transfer for example via email or through Internet browsing via the respective handset 21. As a consequence, each of the handsets 21 is linked to a provider carrier network 30A, 30B. In the example shown, each of the carrier networks 30A, 30B incorporates a corresponding video gateway 31A, 31B forming part of a circuit-switched network and having a corresponding Internet Protocol (IP) adapter 32A, 32B . . . , each of which is typically an Internet Protocol Multimedia Subsystem (IMS) adapter. Each IP adapter 32A, 32B, . . . acts as a bridge between a corresponding video gateway 31A, 31B, in the circuit-switched network and the server 12 in a packet-switched network by providing an open industry standard for voice and multimedia communications over packet-based networks. IMS-based services enable person-to-person and person-to-contact communications including voice, data and multimedia modes. Each of the carrier networks also incorporates a packet-switched network 33A, 33B that facilitates direct connections to the information system 10 without requiring the use of the video gateways 31A, 31B and IP adapters 32A, 32B.

Whilst the arrangement of FIG. 1 illustrates two handsets 21A and 21B and two carrier networks 30A and 30B, it will be appreciated that any specific implementation discussed in the present description requires at least two users each with a corresponding handset 21 and at least one carrier network permitting mobile communications to each of the handsets 21 carried by the users.

A user of a handset 21A who is desirous of utilizing the services offered by the information system 10 establishes a communication path from the handset 21A to the server 10 via a packet-switched network to the information system 10 either directly through the Internet or via the carrier network 30A to which the handset is linked. In this example, the handset 21A is connected to the circuit-switched network operated by the carrier 30A. The IP adapter 32A within the video gateway 32A acts as a bridge between the circuit-switched network of carrier network 30A and the packet-switched based system 10. The user browses the content on the server 12 and enters commands to register, create and modify a user profile on the server 12. The commands are converted by the IP adapter 32A from a circuit-switched communication path to packet-switched communications with the server 12.

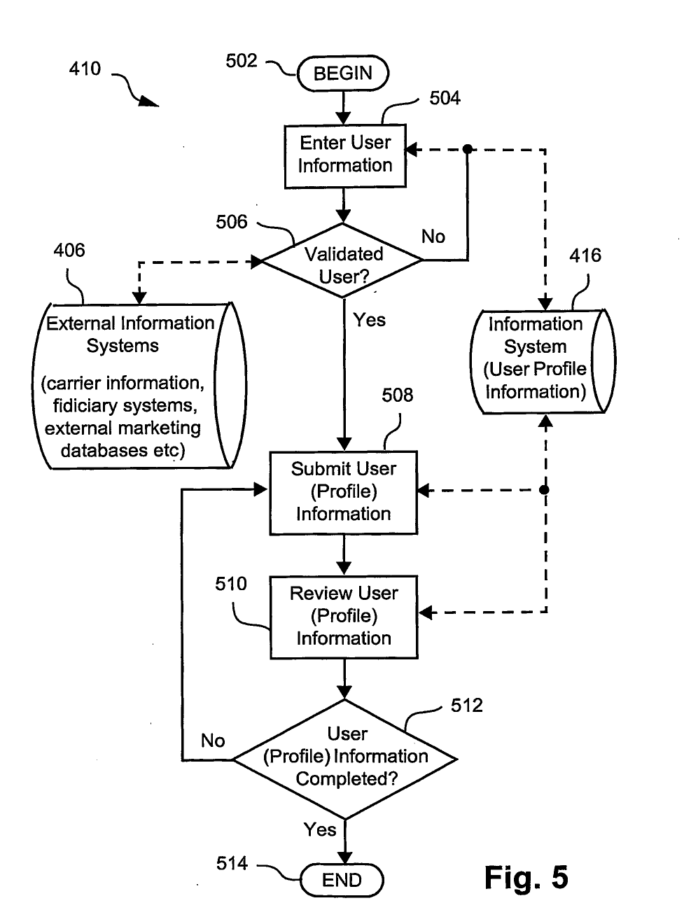

User profile information from the profile database 14 is made available to its corresponding user 20 through the web application server 12. The users 20 are each registered as users of the information system 10 through a user registration procedure, described later with reference to FIG. 5.

Access to and updating of user profile information within the profile database 14 may be performed by each user 20 by manipulating the data capabilities of their corresponding handset 21 to either create, amend, and/or remove features from the user profile information stored on the database 14. The users 20 participate in the information system 10 primarily for the ability to connect and communicate with other users 20 of the system 10 with the option to conceal all their identity prior to any call being connected under control of the system 10.

It is noted at this stage that each of the users 20A and 20B may place traditional telephone or video calls between their respective handsets 21A, 21B via the carrier networks 30A and 30B in a traditional sense via direct connection 55 between the carrier networks 30A and 30B. The direct connection between the carrier networks 30A, 30B can represent either one, or both, of a circuit-switched connection, and a packet-switched connection. Users 20A and 20B may also place and receive traditional calls between their respective handsets 21A and 21B and other handsets, not shown, linked to the same respective provider carrier networks 30A, 30B. Such a traditional communication link is one that may well not hide the caller's identity from the destination party as is intended to be performed through communication connections made via the information system 10.

The system 10 allows users to develop a profile of themselves through a series of questionnaires, surveys, feedback about them from other callers (from previous calls) and their own feedback of other callers in the system 10 (from previous calls). The profile may also contain characteristics based on information stored in the call control database 13. Thus, profile information can be derived from data provided directly from the user, data derived from an analysis of a user's browsing patterns, data derived from an analysis of a user's call patterns, feedback provided by the user in response to a call to one or more other users, and feedback provided by other users. When a connection between two users is terminated, the information system optionally provides a survey or other feedback mechanism by which each user is able to provide feedback relating to the terminated connection. The feedback from a single user can then be used to update either or both of that user's profile and the profile of the other party. A user profile may include many types of information, including, for example, one or more of: the user's name, calling line identifier, alias, picture, work skills, work experience, hobbies, interests, intelligence quotient, emotional intelligence score, social preferences, average call duration, geographical location, personal biases, and demography. It will be appreciated that the actual information stored in a user profile will depend on the particular service to which the system 10 is applied. Accordingly, the preceding types of information that may be stored in a user profile are merely indicative of user profile information and are by no means exhaustive or compulsory. A specific application may utilise one or more or none of those types of information, along with other application specific information.

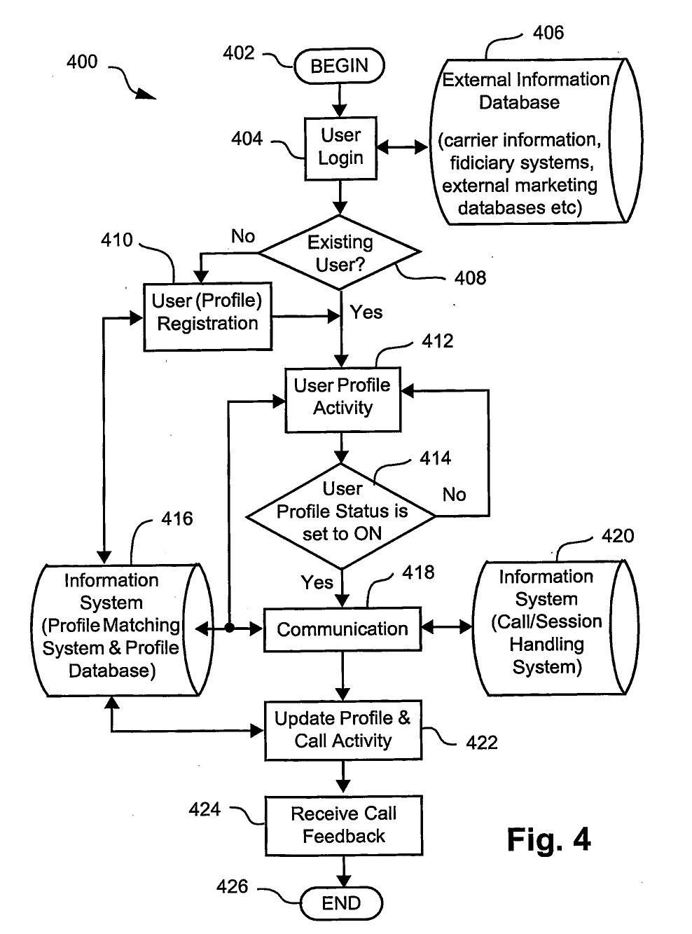

The system 10 allows a user to be ranked in terms of compatibility scores between all other registered users and matched to another caller(s). The system 10 desirably connects two or more callers with high compatibility scores. In this example, two users 20A, 20B each possess mobile handsets capable of supporting video calls, with each of the handsets being connected to a circuit-switched network 30A and 30B, respectively. When the system 10 matches two “on” users 20A, 20B with high compatibility scores, the server 12 establishes two separate calls, one to each of the users, by sending a packet-switched call request to the video gateways 31A, 31B of the carrier provider networks 30 to which the respective users are linked. The packet-switched call requests may be instigated using known packet-switched protocols, including TCP/IP, SIP, and HTTP, for example. IP adapters 32A and 32B in the video gateways 31A, 31B then establish circuit-switched connections to the handsets 21A, 21B. The call requests sent by the server 12 contain a calling line identifier associated with the server 12 or an associated service provider. The call requests do not contain the calling line identifiers of the other matched user. Having established two separate calls to the users 21A, 21B, the server connects the two calls and an end-to-end communication link is achieved without the users' calling line identifiers being revealed. Connection via the system 10 occurs only when matched users have switched their profile “on” (described later with reference to FIG. 4) and without the requirement for callers to present any of their profile information prior to the call being connected.

In the embodiment described above, the system 10 desirably connects two or more users with high compatibility scores. In another embodiment, two or more users are considered to be matched as a result of the users having switched their respective profiles “on”, without further compatibility being determined by the system 10. Such embodiments may be utilised, for example, for special interest groups and the like. In such a scenario, the system 10 is dedicated to a particular interest group and users connected to that system 10 share a common interest and thus a minimum level of compatibility is automatically established, without further matching being performed by the system 10. Thus, two or more users that have their respective profiles “on” are connected by the system 10 so that those users can communicate in respect of the particular interest with which the system is identified.

As described below, the information system 10 provides a collection of web pages which are generated by incorporating data from databases within the system 10, profile identification services, caller identification information and call feedback services. The web pages may include both static web pages and dynamic web pages. The information system 10 also provides a facility for collecting data which callers enter into data input forms, and inserts that data into one or more internal databases. Alternatively, information may be obtained from users via a traditional voice-based telephone call to a human operator, wherein the operator enters relevant data into one or more internal databases. The human operator may be connected to a carrier network 30A, 30B and information collected from the user is transmitted from the carrier network 30A, 30B as data to the information system 10. Alternatively, a voice connection is established between the carrier network 30A, 30B and the information system 10 using VOIP on the packet-switched network and the human operator is connected to the information system.

In a yet further embodiment, an automated menu system is provided for receiving DTMF responses from a user via a telephone keypad, and storing those responses in one or more internal databases. In one embodiment, a user dials a number associated with the information system and a call is established between the user's handset and a menu system hosted by a carrier network 30A, 30B to present multiple choice questions to a user. The number dialed by a user to connect to the information system may contain profiling information, along with the calling line identifier received from the user. The data collected by the menu system is then transferred to the information system 10. In another embodiment, the menu system is hosted by the information system and responses from the user's handset are communicated to the information system for storage in one or more internal databases.

In another example, the handset 21A is connected to the packet-switched network 33A of the carrier network 30A. Such a packet-switched network may be implemented using ATM, for example. In such an implementation, the handset 21 communicates directly with the packet-switched network 33A, which in turn communicates with the information system 10 via a packet-switched network, such as the Internet. If the handset 20B is connected to a corresponding packet-switched network 33B of the carrier network 30B, an end-to-end packet-switched communication path can be established between the two handsets 21A, 21B via the information system 10. In an alternate implementation, the information system 10, having matched two users 20A, 20B, establishes an end-to-end packet-switched communication link between the handsets 21A, 21B via of a packet-switched connection between the packet-switched networks 33A, 33B, without needing to conference calls in the information system 10. The establishment of the communication link may be performed, by example, by providing the appropriate calling line identifiers of the matched users to one or both of the packet-switched networks 33A, 33B along with appropriate instructions to establish the communication link.

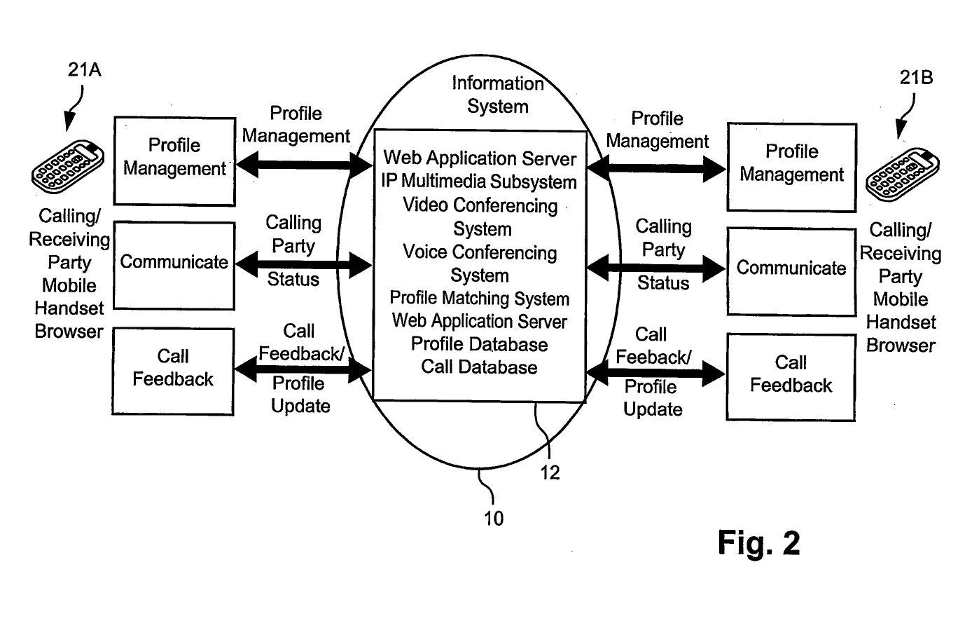

FIG. 2 shows relationships among types of information available to callers and actions that can be taken in using the system 10 of FIG. 1.

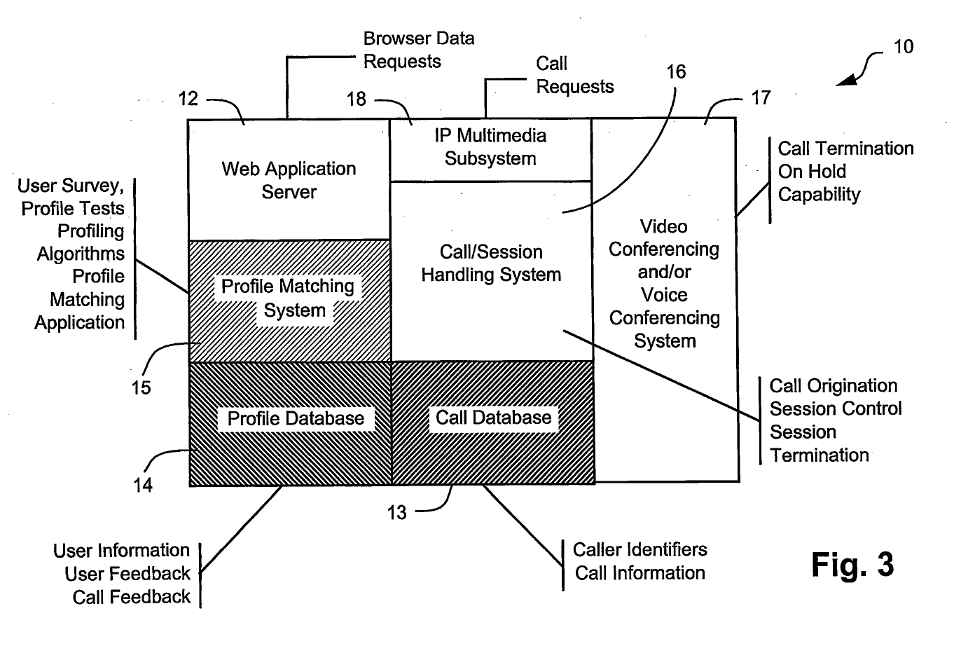

FIG. 3 shows the relationships between various modules forming the information system 10 and which are founded as subsidiary applications operating within the web application server 12. As described above, the web application server 12 receives browser data requests from the handsets 21 via the various carrier networks 30. The requests may be used to update and/or modify the profile database 14 via a profile matching system 15. The matching system 15 may include user inputted surveys, profile tests, profiling algorithms, and a profile matching application to permit matching between profiles relating to individual ones of the users of the system 10.

Sitting alongside the profile matching system 15 and database 14 in the application server 12 is an Internet Protocol (IP) multimedia system 18 which receives and forwards call requests from the carrier networks 30. The call requests are transferred to a call/session handling system 16 which operates to receive a call request and then to match the profile of the requesting party with other profiles that are current and turned “on” within the system 10. The handling system 16 is then configured to provide a call request to the network 30 for a suitably profiled user and thereby to establish, using a video conferencing and/or voice conferencing system 17, call origination, session control and termination between each of the two users. Records of the call including caller identifiers and call information (e.g., time of call) are retained in the call database 13. In this fashion, through the handling system 16, the system 10 is able to establish a call to each of the two or more parties to thereby link the two or more parties in an audio or video call via the conferencing subsystem 17. Specifically, from FIG. 3, it will be appreciated that inter-user calls via the system 10 may be instigated and managed by the call session handling system 16 in such a way that the actual connection between the two parties occurs through the conferencing subsystem 17 and such occurs in response to IP data requests received from the profile matching system from data received from users through the web application server.

In respect of the “profile browsing” embodiment described above, a user browses content provided by the web application server 12. The user identifies a target user with whom communication is desired, and activates a link in a web browser to establish a call to the target user. The web browser sends a request containing an alias associated with the target user to the web application server 12. The web application server 12 passes the request to the call/session handling system 16 to translate the alias into a calling line identifier for the target user. The call/session handling system 16 then presents the translated calling line identifier in a call request to a carrier gateway to establish a call to the target user. In this embodiment, the browsing user knows an alias of the target user, but does not know the calling line identifier or other private information of the target user. In one embodiment, the target user is presented with an alias of the browsing user as part of the call setup from the system 10, but again the calling line identifier of the browsing user is protected. The call request to the carrier gateway can establish a call to the target party, which is then connected to the browsing user by means of the conferencing system 17. Alternatively, the call/session handling system 16 sends a request to the carrier gateway to establish a call from the browsing user to the target party, without needing to utilise the conferencing system 17 of the information system 10. The calling line identifiers of the respective users are not presented to any user by the carrier gateway.

FIG. 4 is a flowchart of a method 400 illustrating the interaction between users and the information system 10. As described in more detail below, these interactions between the users and the system 10 are logged into the databases 13 and 14 for the generation of deeper profile information.

Specifically, the method 400 shown in the flowchart of FIG. 4 is a method performed by an application program forming part of the web application server 12 in order to handle requests from users and connections therebetween. The method 400 commences at a beginning point 402 where the method 400 awaits a request from a user to log in. When a request for a user to log into the system 10 is received at step 404, one or more various external information databases 406 are enabled to afford a record of carrier information, fiduciary systems and external marketing databases which are required to manage the interaction between the system 10 and the various carrier networks 30. These databases can form part of the call database 13.

Upon receiving the request for user log in, which typically arrives as an IP request via the web application server 12, the method 400 then checks at step 408 to determine whether or not the user is an existing user. If the user is unidentified, step 410 follows to perform a user registration activity which takes fundamental profile information for that new user. Step 410 also activates an information system 416 incorporating the profile matching system 15 and the profile database 14. Once the user has been registered at step 410, or if the user is previously registered, step 412 follows where the user profile can be modified, supplemented or have portions deleted according to the particular user's requirements at the time. A test is then performed at step 414 to determine if the user profile status is set to “on”. If not, the method 400 loops back to step 412 whereby the user is again given the option to update their profile.

If at step 414 the profile status is set to “on”, this is interpreted via the web application server 12 that the particular user wishes to engage in a call to another user who is currently also “on” and whose profile matches the requirements established by the present user's profile. Step 418 follows to create a communication between the present user and the already “on” user having a matching, or substantially matching profile. As described above with respect to FIG. 1, there are some embodiments in which two or more users are considered to have matching profiles by virtue of those users being “on” at the same time, without further matching of user profiles being required. Such embodiments may typically relate to special interest groups and the like. Step 418 also includes interaction with the information system 416 including the profile matching system 15 and the profile database 14 as well as an information system 420 forming part of the call session handling system 16.

When the communication between the two users is terminated, step 422 updates the profile and call activity for each of the users, for example for billing purposes and also for future profiling, and step 424 follows to receive any user feedback on the call, for example indicative of the quality of profile matching for further requirements in that regard. The method 400 then ends at step 426.

Registration of a new user at step 410 is shown in greater detail in FIG. 5. Step 410 has an entry point of 502 and at step 504, which follows, the system 10 receives user entered information. This user entered information is received by the system 10 via the web application server 12. Step 506 initially checks to determine whether or not the user is a validated user at step 506. This involves a cross check with external information systems at step 406, for example to determine if the user details that have been entered match those of the carrier. This is to ensure that the actual person who places the request for registration is indeed the authorized user of that particular caller identity as managed by the carrier 30. If the user information is not validated, control returns to step 504 awaiting receipt of further valid information. If valid information is not received, no user registration is performed.

When the user is validated at step 506, step 508 requests input of user information which establishes a basic profile of the user according to the particular application. This involves an updating of the information subsystem 416 and step 510 which follows permits the user to review their profile information. If the user is not satisfied with the profile information as determined at step 512, the user may return to step 508 to perform a further updating of that profile information. The user registration process ends at step 514.

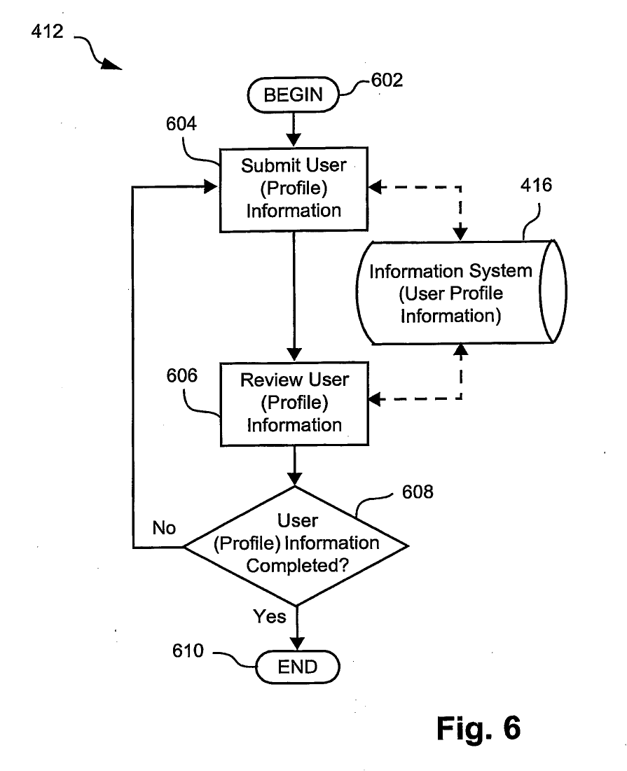

FIG. 6 shows detail of step 412 where the user may update their profile. It will be observed that the various steps 602, 604, 606, 608 and 610 effectively replicate those performed in the user (profile) registration step 410, but as will be appreciated from FIG. 4, these steps may be performed upon each entry to the system 10 of the particular user.

Once a user is validated, they are able to begin inputting their profile information. This is an optional activity, as regardless of what is inputted by the user, a minimum profile of the user is established from information provided by external information systems. Such information may include, for example, the user's identification information, handset identifier and associated handset capability, and physical location.

When the profile information is collected, the user is presented with the option to activate their profile and make the user available to participate in calls. If the user activates their profile, the system 10 through the profile matching system 15 will have pre-identified potentially compatible callers and will begin making calls to connect compatible callers into a communication. If no compatible callers can be found, the system 10 waits until a caller with a suitable profile submits their information into the system 10 and then proceeds to connect the callers.

In one embodiment, the system 10 is associated with a special interest group, whereby connecting to the system automatically establishes a user's profile from the calling information and sets the profile to “on”. The user is subsequently connected by teleconferencing or videoconferencing facilities, as appropriate, to any existing discussion that is ongoing among other users connected to the special interest group system 10.

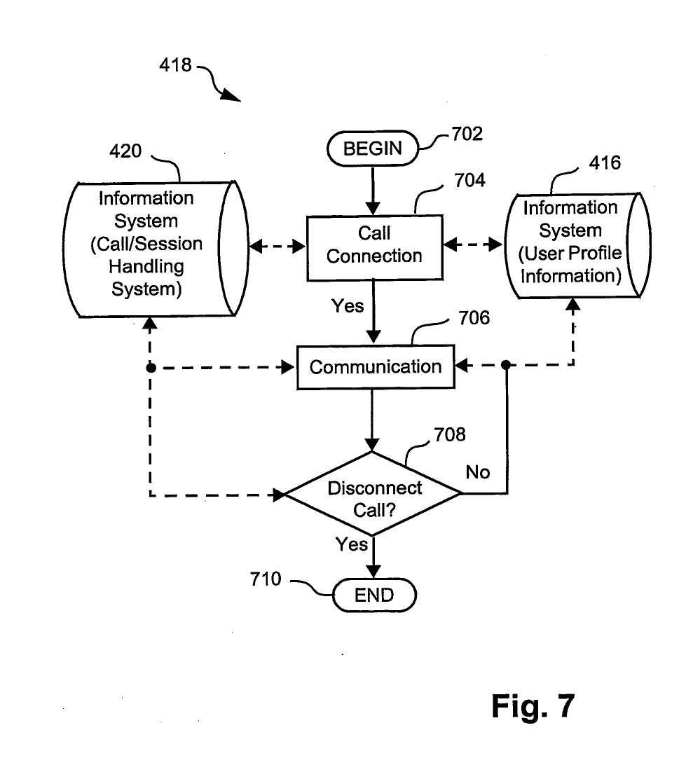

The call connection arrangement step 418 is shown in more detail in FIG. 7, which has an entry point of step 702. At step 704, the system 10 via profile matching system 15 identifies that two users of the system 10 having matching profiles are both currently active on the system 10 and have their profiles turned “on”. At this time, via the call/session handling system 16 and the conferencing system 17, the system 10 via IP multimedia system 18 commences a call to each of the users. The call handling system 16 propagates respective call set-up messages via the IP adapters 32A, 32B in the circuit-switched networks 30A, 30B to each of the two identified users. The system thus establishes separate calls to the two identified users. In this regard, any caller ID information associated with such calls is limited to between the particular user and the system 10 as the call is placed from the system 10 to the particular user. In this sense, each of the users will receive a call identifying the “caller” as being the system 10, or its corporate operator. When each of the users answers the respective calls, the system 10 acknowledges the answering of those calls and then creates an internal connection between the circuit-switched networks coupled to each of the user's mobile handsets (eg. 21A, 21B). The internal connection is typically made by the conferencing system 17. In this sense, the system 10 may be considered the “A” party and the users of the handsets 21A and 21B the “B” parties to a conference call. That connection between the circuit-switched networks is one that can then be performed without the need for transfer of any caller identifier between each of the handsets 21A, 21B. As a consequence, an to end-to-end call (e.g., voice or video) is then established between the two handsets 21A, 21B such that neither handset knows the actual caller identity of the party operating the other handset 21.

The connection between the two parties may, however, involve transfer of a proxy identity, such as an alias, for example as established by each user and recorded in the user profile information in the profile database 14. This proxy identity and any optionally associated profile information may be presented to either party prior to a connection between the parties being initiated. Once confirmation of acceptance of the call from each party is received, the system will connect the call.

In an alternate embodiment, connection of a call between two known aliases is done directly through a circuit-switched network, whereby the Information System 10 translates each party alias or proxy identity and provides the Carrier Network Video Gateway 31A, 31B with each party's calling line identifier and instructions for the call setup. The Carrier Network 30A, 30B then initiates a call to each party without requiring calls to be connected or joined using the conferencing subsystem 17 in the Information System 10.

The communication between the two parties then proceeds at step 706 during which each of the parties may exchange any information using the video and/or audio connection established there between via the circuit-switched networks. Further, as that circuit-switched connection is performed by the conferencing system 17 adjunct to the application server 12, the information system 10 need not record any of the content of that video/audio call. In particular, the two users may choose to exchange identity and/or particular location information as the progress of their call dictates. When either party desires to discontinue the communication of step 706, step 708 detects such a request to disconnect the call. That request to disconnect may be received via an IP communication via the Web Application Server 12 and is then detected by the call session handling system 16 to disconnect the circuit-switched connection formed by the conferencing subsystem 17. Alternatively, the disconnection may be detected by a simple “hanging-up” of one of the mobile handsets 21 by the voice/video system 17, which relays an appropriate message to the call/session handling system 16. When that disconnection occurs, the communication ends at step 710.

Provided that neither of the users have exchanged actual personal identities and/or location information, on cessation of the communication of step 706, neither party will be aware of the identity and/or location of the other party with whom a call had just been made.

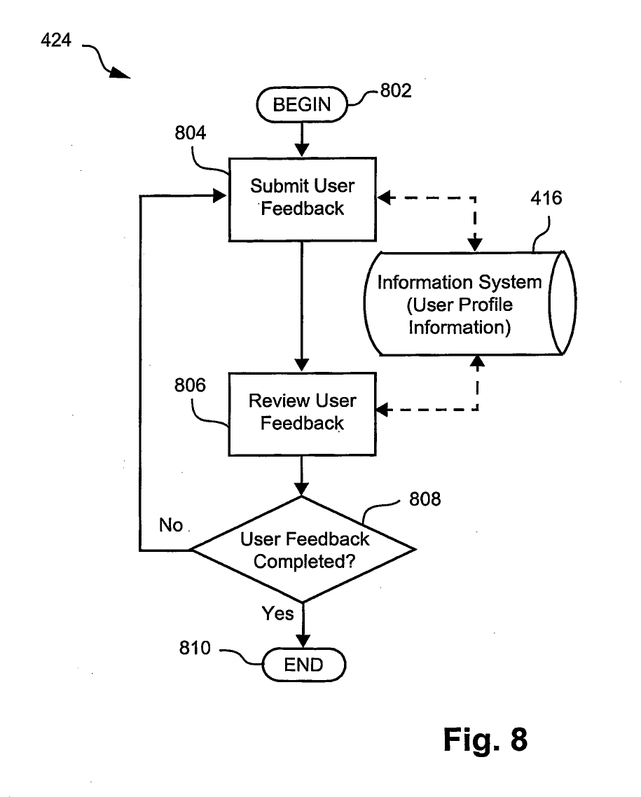

In the course of communication, a caller is able to assess the extent of profile match and once the call is disconnected the user may be presented by the information system 10 with a request to offer feedback about the matching compatibility. This is shown in detail in FIG. 8 for step 424 of FIG. 4. After an entry point 802, step 804 operates to provide the user with a form or template by which feedback may be entered via the web application server 12. That form is updated with information from the information system 416 of the user's and other party's profile. At step 806, the user may review any feedback and at step 808 is invited to add or alter the feedback. If the user, wishes to add or alter feedback, control returns to step 804. If feedback entry processing has been completed, the subroutine ends at step 810. Any such feedback information is stored in the databases 13 and 14 and adds more detail to a user's profile.

On conclusion of a call, the parties may be prompted to authorize the system 10 to release or otherwise reveal their actual caller identity, thereby permitting each of the parties to subsequently contact one another without a need for the system 10 to be interposed.

In another implementation, a user may recall or record from a previous session a proxy identity or alias of a previous acquaintance. If such is the case, rather than simply notify the system 10 that the particular user is “on” and available via the system 10, the user may, via a browser data request to the web application server 12, access the profile database 14 to seek a profile of a target party in whom the user has interest. Such may be identified by a known alias. Upon identifying the target party, the user may access a link via the web application server 12 contained within that party's profile. When a user accesses such a link, a check is made to determine if the target party is available or “on” the system 10, and if so the system 10 can then establish a call to the target party to thereby form a connection with between user and the target party. The establishment of a connection to the target party may be performed as described previously, by making a call to the target party and then conferencing the user and the target party. Alternatively, the system may send an appropriate request, containing the relevant calling line identifiers of the user and target party, to a carrier network 30A, 30B to establish a call directly between the user and target party without disclosing the calling line identifiers to any party. In this scenario, the system does not provide any call conferencing capability. Thus, the system 10 may be used for profiled but otherwise blind matching between parties, or for discreet or anonymous connection between otherwise “known” parties.

The information system 10 may have a reporting system (not illustrated) that gathers data on the activities of users within the system 10 and generates call activity and profile reports. The activity reports can include both scheduled reports and customized reports. The scheduled reports can include, for example, reports on:

usage of the system by callers;

profiles of the callers;

trends in profiles; and

trends in call usage.

These reports can be used to further develop profile models and profile tests to enhance the information systems. The actual reports used will depend on the particular application for which the information system is adapted.

In one embodiment, the information system 10 affords commercial utility by charging users subscription fees (eg. on a monthly basis) for use of the services offered thereby. Further, through the call database, the system 10 may participate in “on-net” billing where the system 10 transfers call costs for each of the users to their respective carrier networks 30a and 30b. Such calls would appear on the user's monthly bill as being calls between the user and the system 10. An alternative is for the system 10 to engage in “off-net” billing, where the system 10 negotiates its own call rates with the carriers 30a and 30b as it is the system 10 that effectively places the calls, and the system 10 then on-charges call costs, perhaps at a premium, to each of the users in addition to monthly subscription. Such call costs are based on information recorded in the call control database 13. Such “off-net” billing may afford the system 10 the opportunity to offer special rates for frequent users of the system 10 or based on other profile information.

The information system 10 affords a number of advantages over existing arrangements. Significantly, taking control of direct communication to each of the users of the system provides the system 10 with the ability to manage matches between users as well as protecting the identity of each of the users and affording utility in providing effectively anonymous connections between users that may be discontinued at any user's whim or maintained as desired.

The information system 10 also presents the opportunity for a corporate operator to apply a game theory on communication with unknown parties. In such an implementation, the information system is operated by the corporate operator and the web application server 12 presents content relating to a game. Further promotion of the game may be provided in other media, such as radio, newspapers, magazines, SMS text messages, and television. Users wishing to participate in the game establish profiles on the web application server 12, which matches contestants in accordance with predetermined criteria and subsequently connects two or more contestants in a voice, video or data call. As previously described, a communication link is established between matched contestants without disclosing the calling line identifiers of any one contestant to the other matched contestant/s.

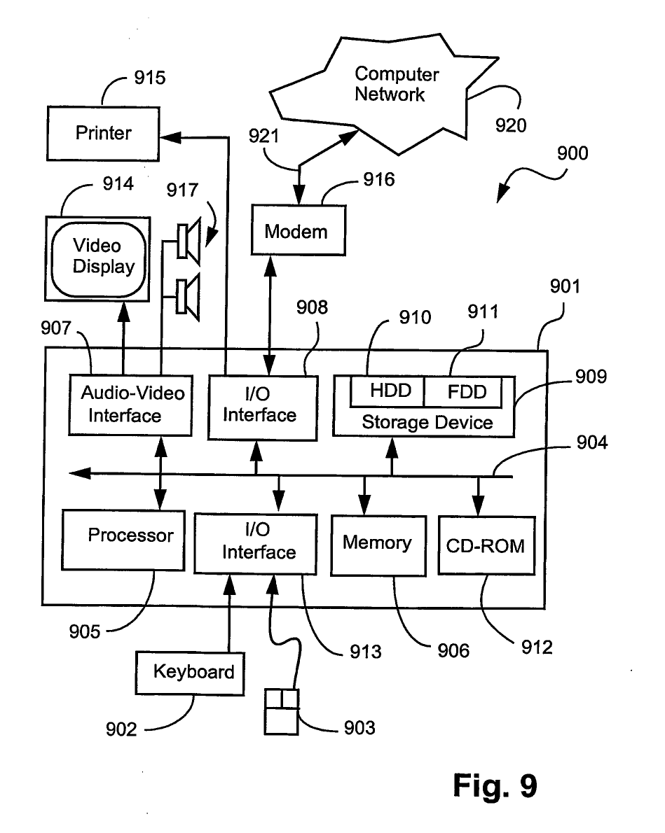

The methods described above and the information system 10 are preferably practised using a general-purpose computer system 900, such as that shown in FIG. 9 wherein the processes of FIGS. 1 to 8 and 10 and 11 (to be described) may be implemented with software, such as an application program executing within the computer system 900. In particular, the steps of forming a communication link between two parties without passing identification information between the parties, and any associated profiling, are effected by instructions in the software that are carried out by the computer. The instructions may be formed as one or more code modules, each for performing one or more particular tasks. The software may also be divided into two separate parts, in which a first part performs the communication coupling methods and a second part manages interfaces between the first part and the users. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for communicating between parties in an anonymous fashion.

The computer system 900 is formed by a computer module 901, input devices such as a keyboard 902 and mouse 903, output devices including a printer 915, a display device 914 and loudspeakers 917. The computer system 900 thus may operate as the information system 10 where the devices 902, 903, 914, 195 and 917 are afforded for operation of the system 10 by an administrator thereof. A Modulator-Demodulator (Modem) transceiver device 916 is used by the computer module 901 for communicating to and from a communications network 920, for example connectable via a telephone line 921 or other functional medium such as a broadband, ISDN or wireless link. The modem 916 can be used to obtain access to the Internet, and other network systems, such as a Local Area Network (LAN) or a Wide Area Network (WAN), and may be incorporated into the computer module 901 in some implementations.

The computer module 901 typically includes at least one processor unit 905, and a memory unit 906, for example formed from semiconductor random access memory (RAM) and read only memory (ROM). The module 901 also includes an number of input/output (I/O) interfaces including an audio-video interface 907 that couples to the video display 914 and loudspeakers 917, an I/O interface 913 for the keyboard 902 and mouse 903 and optionally a joystick (not illustrated), and an interface 908 for the modem 916 and printer 915. In some implementations, the modem 916 may be incorporated within the computer module 901, for example within the interface 908. A storage device 909 is provided and typically includes a hard disk drive 910 and a floppy disk drive 911. A magnetic tape drive (not illustrated) may also be used. A CD-ROM drive 912 is typically provided as a non-volatile source of data. The components 905 to 913 of the computer module 901, typically communicate via an interconnected bus 904 and in a manner which results in a conventional mode of operation of the computer system 900 known to those in the relevant art. Examples of computers on which the described arrangements can be practised include IBM-PC's and compatibles, Sun Sparcstations or alike computer systems evolved therefrom.

Typically, the application program is resident on the hard disk drive 910 and read and controlled in its execution by the processor 905. Intermediate storage of the program and any data fetched from the network 920 may be accomplished using the semiconductor memory 906, possibly in concert with the hard disk drive 910. In some instances, the application program may be supplied to the user encoded on a CD-ROM or floppy disk and read via the corresponding drive 912 or 911, or alternatively may be read by the user from the network 920 via the modem device 916. Still further, the software can also be loaded into the computer system 900 from other computer readable media. The term “computer readable medium” as used herein refers to any storage or transmission medium that participates in providing instructions and/or data to the computer system 900 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 901. Examples of transmission media include radio or infra-red transmission channels as well as a network connection to another computer or networked device, and the Internet or Intranets including e-mail transmissions and information recorded on Websites and the like.

The modem 916, as providing the connection to the network 920, which desirably represents the Internet, of which the carrier networks 30a and 30b, is thus the avenue by which at least packet-switched communication between the information system 10 and the handsets 21a, 21b occurs.

The arrangement of FIG. 9 may alternatively be supplemented by dedicated hardware such as one or more integrated circuits performing the functions or sub functions of communication coupling. Such dedicated hardware may include circuit switches, digital signal processors, or one or more microprocessors and associated memories and operable to perform the circuit-switched connections described above between the information system 10 and each of the handsets 21a, 21b.

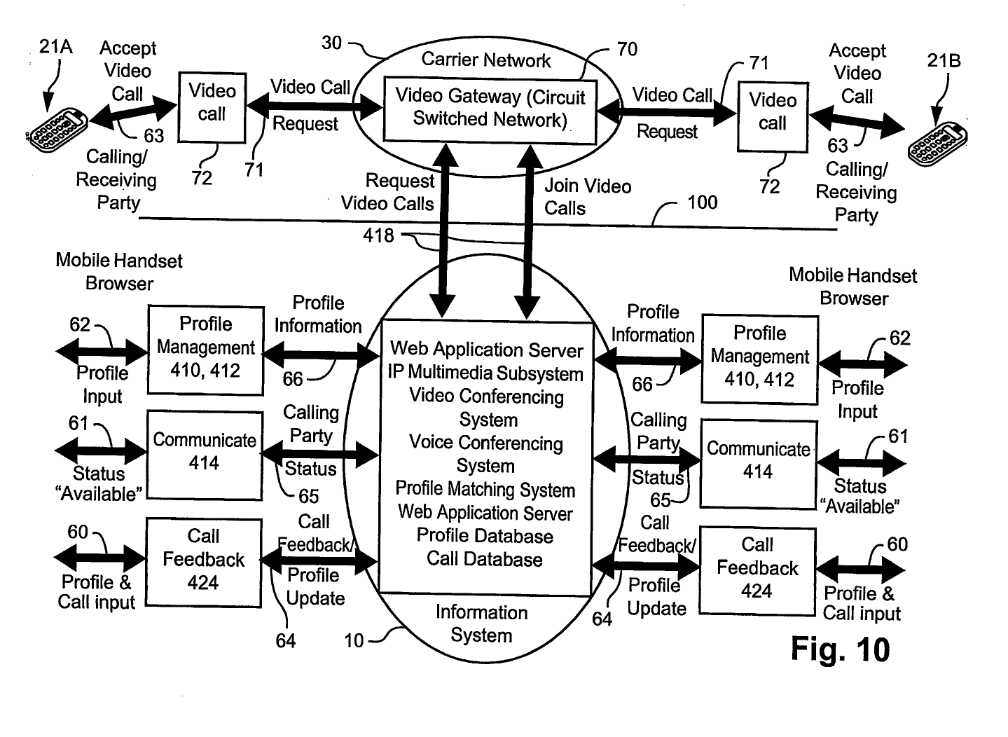

FIG. 10 shows an implementation of the arrangement of FIG. 1 whereby the carrier networks 30A and 30B have been unified as a single network 30. An arbitrary line 100 is indicated in FIG. 10 to delineate a distinction between packet-switched communications in the lower half of the drawing and circuit-switched communications occurring in the upper half of the drawing. As previously discussed, communications between two handsets 21A and 21B may occur via both packet-switched and circuit-switched forms and in this implementation, packet-switched communications occur through the profile management 410, 412, communication 414 and call feedback 424 modules via which respective inputs 62, 61 and 60 are made each of which accesses the information system 10.

In the implementation of FIG. 10, the information system 10 having established the various profiles of the users of the handsets 21A and 21B and having established that each user has a status of “available” 61, creates a packet-switched IP based request 418 which crosses the arbitrary boundary 100 to a video gateway 70 forming part of the carrier network 30. The video gateway 70 thus forms a connection between the packet-switched communication and circuit-switched communication afforded by the network 30. As shown earlier in respect of FIG. 1, the connection may be effected by an IP adapter 31. As a consequence, the information system 10 can operate in this configuration through only an IP/packet-switched connection to one or more carrier networks 30 which inherently have systems configured to accommodate both packet-switched and circuit-switched communications between the handsets 21A and 21B. In this fashion, upon receiving a command 418 from the information system 10 to create the connection, the video gateway 70 creates a video call request 71 which establishes a circuit-switched video call 72 to the respective handsets 21A and 21B. The user of the handset may accept that call 63 via the video gateway 30. If both parties accept the call, the system 10 creates an internal connection between the handsets 21A and 21B. That form of connection may be implemented by three methods. First is a Session Initiation Protocol (SIP) based video conference where a session is initiated when the information system 10 begins making calls to the circuit switch network 70. Once two calls are active, they are then “bridged” or “joined” in an SIP video conference, as well known in the art. A second alternative is a circuit-switched network connection video call. In this implementation, a session is initiated by the information system 10 and appropriate commands are sent to the circuit-switched network 70 to simulate one party sending a call request to the other party. This form of implementation may not be available in all networks 30, as proprietary technology in some cases does not support such call control. A third alternative is similar to the first, whereby an IP based video conference is initiated by the information system 10 and is presented to a packet-switched (as opposed to circuit-switched) Video Gateway in the Carrier Network 30. This third alternative may not be available in all networks 30, as proprietary packet-switched network technology may not be supported.

Once communication is established under the arrangement of FIG. 10, the information system 10 may monitor administrative issues arising from the call connection (i.e. time of call, call charges etc) but is not able to monitor the actual content which is the speech or video communicated between the parties operating the handsets 21A and 21B.

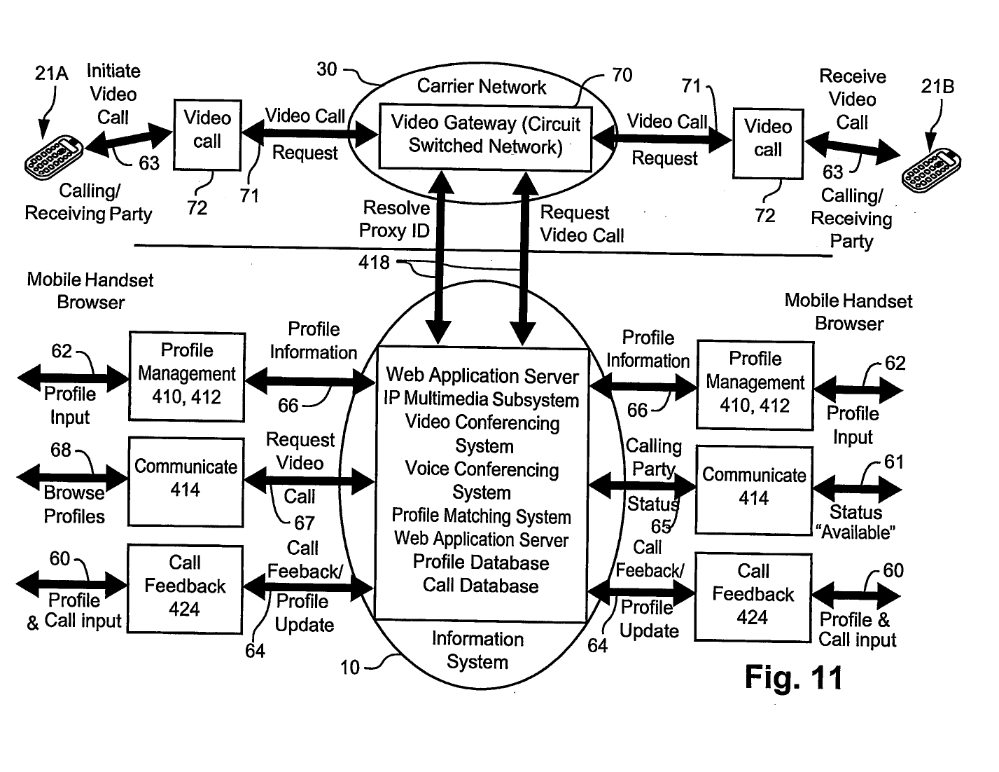

FIG. 11 represents an arrangement similar to that of FIG. 10 and in which corresponding reference numbers have the same meaning. In FIG. 11, the user of the handset 21A, rather than indicating that a status is “available” 61, is browsing profiles 68 available via the information system 10. This may be for example browsing a list of profiles with whom that party has previously communicated and with which access has been granted according to a calling identifier (e.g. a proxy identifier known only to the information system 10). Alternatively, the party of the handset 21A may browse the public list of caller identifiers, and optional profile information such as photos, videos and biographical details, and chooses to connect a call to a particular person (i.e. via a proxy identifier).

In either scenario, the user of the handset 21A views a website via their mobile handset 21A and selects for example a link which represents a proxy identifier that is resolved by the information system 10 and results in the system 10 establishing a call to the resolved number and thus to the other party in possession of the handset 21B to allow a circuit-switched end-to-end call to be made from the browsing party to the party identified via the link. The video call may be implemented in the same fashion as that described above with reference to FIG. 10. During the video call, further browser-based interaction may occur and in this fashion, profile and call input can be made via the call feedback arrangement 424 during the progress of the video call 72. The parties may also communicate by sending files (e.g. pictures, video etc) during the course of the video call 72.

In each instance, each of the parties of the handsets 21A and 21B is not advised of the real identity of each other unless they purposefully exchange that information via the video call or through some other exchange.

### INDUSTRIAL APPLICABILITY

The present invention finds industrial application in the provision of telecommunications services between individual users of mobile handsets having a data capability and at least one of an audio and video capability.

The foregoing describes only some embodiments of the present invention, and modifications and/or changes can be made thereto without departing from the scope and spirit of the invention, the embodiments being illustrative and not restrictive.

1. A method of forming an end-to-end communication between at least two communication devices, each communication device being connected to a communication network and having at least one associated calling identity, said method comprising the steps of:
(a) receiving, at a third party in a packet-switched communication network, a communication from a first communication device indicating at least an availability for communications, the indication including an identifier of the first communication device;
(b) identifying, at the third party, at least one second communication device as available for compatible communications with said first communication device, the availability being advised via a packet-switched communication derived from the second communication device, the identifying including an identifier of the second communication device;
(c) instigating, from the third party, a call to the first communication device and a call to the second communication device, each based upon the corresponding identifiers; and
(d) upon establishment of each call to the first and second communication devices, joining the calls such that the communication devices are in an end-to-end communication, said joining occurring without transfer of the associated calling identities between the communication devices.

2. The method according to claim 1, wherein each of said identifiers is selected from the group of identifiers consisting of: calling identity, device identifier, Instant Messaging Identifier (IMI), and email address.

3. The method according to claim 1, wherein said identifier of said first communication device is a calling line identity.

4. The method according to either one of claims 1 and 3, wherein said identifier of said second communication device is a calling line identity.

5. The method according to any one of claims 1 to 4, wherein at least one of the communication devices is pre-registered with the third party and the identifying of the identifier of that communication device comprises retrieving the corresponding identifier from a database of the third party.

6. The method according to claim 1, wherein the identifier is conveyed by the packet-switched communication and identified by the third party from the packet-switched communication.

7. The method according to any one of the preceding claims, wherein step (c) comprises:
sending a packet-switched communication from the third party to a fourth party and comprising the identifiers of each of the first device, the second device and the third party, such that the fourth party establishes the calls to the first and second communication devices.

8. The method according to claim 7, wherein step (d) comprises the fourth party providing packet-switched communication to the third party including information regarding the joined call.

9. The method according to claim 8, wherein said information comprises a duration of the joined call.

10. The method according to any one of the preceding claims, wherein said packet-switched communication is used to one of create or modify profile information associated with the corresponding communication device.

11. The method according to claim 10, wherein step (b) comprises comparing profile information associated with each of a plurality of available communication devices to profile information associated with the first communication device to identify the second communication device as a best match between the compared profile information.

12. The method according to either one of claims 10 and 11, wherein the profile information is stored at the third party.

13. The method according to any one of the preceding claims, wherein said first and second communication devices are connected to respective circuit-switched communication networks.

14. The method according to claim 13, wherein the instigation of calls to each of the first and second communication devices includes the sending of a packet-switched communication from said third party to an adapter in each of said circuit-switched networks to which said first and second communication devices are connected, the respective adapters establishing a circuit-switched call to the first and second communication devices.

15. The method according to claim 14, wherein said adapters are Internet Protocol Multimedia Subsystem adapters.

16. The method according to claim 1, wherein said first and second communication devices are connected to respective packet-switched communication networks.

17. The method according to claim 10, comprising the further step of:
modifying a user profile associated with at least one of said communication devices based on data relating to said end-to-end communication.

18. The method according to claim 17, wherein said data includes a duration of said end-to-end communication.

19. The method according to claim 17, wherein said data is based on feedback derived from at least one of said communication devices after termination of said end-to-end communication.

20. A method of forming an end-to-end communication between at least two communication devices, said method comprising the steps of:
(a) receiving at a third party a communication derived from a first communication device, the communication including an identifier of the first communication device;
(b) identifying, at the third party at least one second communication device as available for compatible communications with said first communication device, the availability being advised by a communication derived from the second communication device, the identifying including an identifier of the second communication device;
(c) instigating, from the third party, respective calls to each of the first and second communication devices using the corresponding identifiers and, on establishment of the calls, joining the calls to establish end-to-end communication between said first and second communication devices, said joining occurring without transfer of call identities between the communication devices.

21. The method according to claim 20, wherein said third party is connected to a packet-switched network and each of said communications derived from said first and second communication devices is a packet-switched communication.

22. The method according to claim 20, wherein said first communication device is connected to a circuit-switched network and step (a) comprises receiving a circuit-switched communication from the first communication device at a proxy location and said proxy location notifying the third party via a packet-switched communication.

23. The method according to claim 20, wherein at least the second communication device is pre-registered with the third party and the identifying of the identifier of that communication comprises retrieving the identifier from a database of the third party.

24. The method according to claim 20, wherein the communication from the second party is used to create or modify profile information associated with the corresponding communication device.

25. The method according to claim 20, wherein said communication derived from said first communication device is a circuit-switched communication interpretable to form profile information associated with the first communication device.

26. The method according to claim 25, wherein the associated profile information is interpreted from Dual Tone Multi-Frequency (DTMF) codes and a circuit-switched menu afforded to a user of the first communication device during the communication of step (a).

27. The method according to claim 26, wherein said DTMF codes are in response to an automated menu provided by one of said third party and a circuit-switched carrier.

28. The method according to claim 20, wherein said communication derived from said first party is a packet-switched communication that includes profile information associated with the first communication device.

29. The method according to claim 28, wherein said profile information includes a calling identity.

30. The method according to claim 28, wherein said profile information includes a communication device capability.

31. The method according to claim 25, wherein the method further comprises translating the profile information into data for comparison against profile data for a plurality of available communication devices and from which a matching process occurs to identify the second communication device as a best match.

32. The method according to claim 20, wherein the third party identifies a plurality of communication devices available for communications at step (b), based on a matching of profile information associated with the first communication device against profile data for a plurality of available communication devices.

33. The method according to claim 32, wherein at step (c) the third party instigates a call to the first party and a respective call to each of the plurality of identified communication devices, and joins the call to the first communication device to the respective calls to each of the plurality of identified communication devices to establish a conference call.

34. A system for forming an end-to-end communication between at least two communication devices, said system comprising:
a first communication device having an associated calling identity;
at least one second communication device having an associated calling identity;
a communication network permitting communications between each of the communication devices;
a server connected to the communication network, said server including:
means for receiving a communication from said second communication device indicating an availability of that device for receipt of a call;
means for receiving a communication from said first communication device indicating an availability for communication with at least one of the other communication devices;
means for matching a profile associated with said first communication device to a profile associated with at least one of said second communication devices;
means for instigating, via the communication network and utilising said calling identities, a call to said first communication device and a call to said second communication device associated with said matched profile; and
means for joining said calls to said respective devices to establish an end-to-end communication between the communication devices associated with the matched profiles, without disclosing the associated calling identities to any other communication device in said joined call.

35. A system for forming an end-to-end communication between at least two communication devices, said system comprising:
at least one first communication device having a circuit-switched mode of operation and a packet-switched mode of operation;
at least one second communication device having a circuit-switched mode of operation and a packet-switched mode of operation, each of the devices incorporating an associated call identity communicable via communications made therewith;
a communication network incorporating both packet-switched and circuit-switched networks and permitting communications between each of the communication devices; and
a server connected for at least packet-switched communication with said communication network, said server comprising:
means for receiving a packet-switched communication from the second communication device indicating an availability of that device for receipt of a circuit-switched call;
means for receiving an indication from the first communication device as to its availability for circuit-switched communication; and
means for instigating, via the communication network, at least a circuit-switched communication call to the second communication device and for joining of that call to the first communication device such that the call identities of each of the devices is unknown to each of those devices as a result of the joined call.

36. The system according to claim 35, wherein the first communication device indicates its availability via a packet-switched communication to the server, and the server instigates a circuit-switched call to the first communication device and a circuit-switched call to the second communication device and, upon establishment of each of the calls, the calls are then joined in such a manner to prevent the revelation of the associated calling identities to each of the communication devices.

37. The system according to claim 36, wherein instigation of the circuit-switched calls to the first and second communication devices includes a packet-switched communication from said server to at least one proxy server in a circuit-switched network, said at least one proxy server establishing said circuit-switched calls to the first and second communication devices.

38. The system according to claim 36, wherein the first communication device indicates availability by placing a circuit-switched call via the communication network, the circuit-switched call being identified by the server and consequently joined to a call made to the second communication device.

39. The system according to claim 38, wherein said server translates an identifier stored in a user profile associated with said second communication device to facilitate instigation of the call to said second communication device.

40. The system according to claim 35, further comprising:
at least one adapter in said communication network for facilitating communication between a packet-switched network and a circuit-switched network.

41. A server apparatus for enabling communication between at least two communication devices, the apparatus comprising:
a module for identifying availability of a first communication device for receipt of a call, said server receiving a call identity associated with said first communication device in a communication from said first communication device;
a communication module for receiving a communication from at least one second communication device, the communication at least including an indication of availability of one of the communication devices for receipt of a call and a calling identity associated with said second communication device;
a module for matching a user profile associated with the first communication device with a user profile associated with the second communication device; and
a module for causing a communication network to establish a joined call connection between the matched first and second communication devices in such a fashion that the devices are unaware of the calling identities associated with each of the other of the devices.

42. The server according to claim 41, wherein the joined call is a conference call connection established by a call gateway of the communication network.

43. A profiling system for establishing communication between a plurality of parties, said profiling system comprising:
a server connected to a communications network, wherein said server includes:
a database for storing user profiles, wherein each of said plurality of parties has an associated user profile;
a processor for processing data contained in said user profiles to determine a match between at least two of said plurality of parties in accordance with predetermined criteria; and
a call handling module for initiating a call in the communications network to at least two of the matching parties to establish communication between the matching parties.

44. The profiling system according to claim 43, wherein each of said user profiles includes a calling identity, and said call handling module establishes communication between the matching parties without disclosing the calling identities to any of the matching parties.

45. The profiling system according to either one of claims 43 and 44, further comprising:
a conferencing module, wherein the call handling module establishes an independent call via the communications network to each of the matching parties and the conferencing module connects the independent calls to establish communication between the matching parties.

46. The profiling system according to claim 45, wherein said conferencing module is a teleconferencing module.

47. The profiling system according to claim 45, wherein said conferencing module is a videoconferencing module.

48. The profiling system according to claim 45, further comprising:
a profiling module for receiving user data from each of said plurality of parties to establish said user profiles.

49. The profiling system according to claim 48, wherein said profiling module presents a survey to each of said plurality of parties to elicit said user data.

50. The profiling system according to claim 49, wherein said profiling module converts user data derived from Dual Tone Multi Frequency (DTMF) codes to establish said user profiles.

51. The profiling system according to claim 48, wherein said user data is presented in a packet-switched communication to said server.

52. The profiling system according to claim 51, wherein said packet-switched communication is an Internet Protocol (IP) based communication.

53. The profiling system according to claim 48, wherein said profiling module modifies said user profiles in response to further user data derived from said communication between the matching parties.

54. The profiling system according to claim 53, wherein said further user data is presented to the profiling module from the call handling module.

55. The profiling system according to claim 53, wherein said profiling module presents a further survey to at least one of said matching parties upon termination of said communication between the matching parties, to obtain said further user data.

56. The profiling system according to claim 43, wherein said user profiles include user information selected from the group of user information consisting of: party name, name alias, sex, calling identifier, picture, video, vital statistics, time information, work skills, work experience, intelligence quotient, emotional intelligence score, social preferences, personal biases, demography and geography.

57. A method of forming an end-to-end communication between at least two communication devices, each communication device connected to a communication network and having at least one associated calling identity, said method being substantially as described herein with reference to the accompanying drawings.

58. A method of forming an end-to-end communication between at least two communication devices, said method being substantially as described herein with reference to the accompanying drawings.

59. A system for forming an end-to-end communication between at least two communication devices, said system being substantially as described herein with reference to the accompanying drawings.

60. A server apparatus for enabling communication between at least two communication devices, the apparatus being substantially as described herein with reference to the accompanying drawings.

61. A profiling system for establishing communication between a plurality of parties, said profiling system being substantially as described herein with reference to the accompanying drawings.
